(19) United States
(12) Patent Application Publication
(10) Pub. No.: US 2015/0122821 A1
(43) Pub. Date: May 7, 2015

(54) ISO MODAL CONTAINER

(71) Applicant: Francesco Nettis, London (GB)

(72) Inventor: Francesco Nettis, London (GB)

(73) Assignee: Blue Wave Co S.A., Luxembourg (LU)

(21) Appl. No.: 14/363,257

(22) PCT Filed: Dec. 5, 2011
(86) PCT No.: PCT/EP2011/071817

§ 371 Date: Dec. 19, 2014

(51) Int. Cl. F17C 1/00

(52) U.S. Cl. CPC F17C 1/005; F17C 1/002
USPC 220/560.11

(57) ABSTRACT

An ISO modal container for storage and transportation of a CNG pressure vessel comprises a main longitudinal portion and two end caps, one at each end of the main longitudinal portion. The container comprises a frame body for housing a single pressure vessel inside said frame body. The frame body comprises two sides connected by longitudinally extending beams. A pair of attachments, one at each end of the pressure vessel, holds the pressure vessel suspended in place inside the frame body, with the longitudinal portion of the pressure vessel substantially parallel to the longitudinally extending beams of the frame body of the container. The pressure vessel is typically of the type 3 or type 4 class.

The present invention relates to ISO modal containers. In particular, the present invention relates to ISO modal containers for transporting compressed natural gas (CNG).

An ISO modal container, or “intermodal” container, is a standardised, reusable container for storage and transportation of materials or goods which can be moved from one mode of transport to another without unloading and reloading the materials or goods. For example, an ISO modal container can be unloaded from a ship and then loaded directly onto a train. From the train, the ISO modal container can then be loaded directly into a cargo airplane, etc. The ship, train and airplane are all configured for receiving and transporting the standardised ISO modal container, or more than one thereof.

Characteristics such as shapes, materials of construction, maximum dimensions, weights and stacking and interlocking features, etc., are prescribed in relevant Standards, and there can be various forms of ISO modal container each categorised according to those Standards. Standard ISO modal containers are therefore readily identified by reference to a particular Standard, which Standards provide recognisable codes of certification, such as “ISO 6346” and others.

Natural gas can be found in underwater wells. The natural gas can be extracted from its source and it can then be stored in the form of compressed natural gas (CNG) in suitable pressure vessels, and those pressure vessels can be transported on ships to shore-based processing plants. For this purpose, a suitable attachment or anchorage structure between the pressure vessels and the ship is needed. To date this has been proposed to be achieved with semi-permanent mounting of the pressure vessels, typically horizontally, within the hull of the ship.

A proposal is to use ISO modal containers, since they are already transportable on ships, and are of a size to accommodate CNG pressure vessels. However, to date the transportation of CNG using ISO Modal containers has not been economically achievable. The present invention seeks to address this by providing an economically viable solution.

Pressure vessels for the transport of compressed fluids presently constitute four regulatory agency approved classes or types, all of which are cylindrical with one or two domed ends:

Type I. Consists of an all metal, usually aluminum or steel, construct. This type of vessel is inexpensive but is very heavy in relation to the other classes of vessels. The entire vessel is of sufficient strength to withstand the intended pressure exerted on the vessel by a contained compressed fluid and therefore does not require any manner of strength-enhancing over-wrap, including the dry filamentous over-wrap of this invention. Type I pressure vessels currently comprise a large portion of the containers used to ship compressed fluids by sea, their use in marine transport incurs very tight economic constraints.

Type II. Consists of a thinner metal cylindrical center section with standard thickness metal end domes such that only the cylindrical portion need be reinforced, currently with a composite over-wrap. The composite wrap generally constitutes glass or carbon filament impregnated with a polymer matrix. The composite is usually “hoop wrapped” around the middle of the vessel. The domes at one or both ends of the vessel are of sufficient strength to withstand the pressures developed in the vessel under normal use and are not composite wrapped. In type II pressure vessels, the metal liner carries about 50% of the stress and the composite carries about 50% of the stress resulting from the internal pressure of the contained compressed fluid. Type II vessels are lighter than type I vessels but are more expensive.

Type III. Consists of a thin metal liner that comprises the entire structure, that is, the cylindrical center section and the end dome(s). Thus, the liner is currently reinforced with a filamentous composite wrap around entire vessel. The stress in Type III vessels is shifted virtually entirely to the filamentous material of the composite wrap; the liner need only withstand a small portion of the stress. Type III vessels are much lighter than type I or II vessels but are substantially more expensive.

Type IV. Consists of a polymeric, essentially gas-tight liner that comprises both the cylindrical center section and the dome(s), all of which is currently fully wrapped with a filamentous composite. The composite wrap provides the entire strength of the vessel. Type IV vessels are by far the lightest of the four approved classes of pressure vessels but are also the most expensive.

As noted above, Type II, Ill and IV pressure vessel currently require a composite over-wrap over a vessel liner to give them the necessary strength to withstand the intended pressure exerted by a compressed fluid contained in the vessel. It is known, however, that the polymeric matrix of the composite wrap adds little or no strength to the overwrap. Thus, this invention also can be used with novel winding arrangements using a dry filamentous material that is disposed over a pressure vessel liner in a dry state and that is remains in essentially a dry state (i.e. not bonded throughout with an impregnation of resin) for the life-time of the pressure vessel.

“Essentially” in a dry state takes into consideration that, in use, particularly for marine transport of compressed fluids, the filamentous material may inadvertently become dampened by environmental moisture and the like. That is, the dry filamentous material is intended to be disposed over the vessel dry and to be dry when the vessel is put in use. Essentially dry in this context therefore does not exclude situations where the filaments/fibres are wetted by water.

It is thought that to maximise the volumetric capacity of an ISO Modal container, it is best to make the pressure vessel as large as possible. This then would in theory maximise the amount of CNG that can be transported within the ISO Modal container, whereby CNG pressure vessels can be conveniently used to transport the CNG from one location to the next in the ISO modal containers, either on specialised CNG vehicles, including ships, trains or trucks, i.e. ones that exclusively transport CNG, or on standard ISO modal container vehicles, i.e. ones which transport other ISO modal containers as well. CNG pressure vessels, however, pose specific concerns when it comes to transporting them within ISO modal containers due to the fact that the CNG within the pressure vessels is at a very high pressure—usually in excess of 200 bar.

Non-CNG-suitable forms of pressure vessel have been incorporated into ISO modal containers, but they are unsuitable for CNG since their vessel walls are fabricated only with sufficient strength to accommodate the intended pressures for their intended cargo (e.g. LPG or LNG—each involving significantly lower pressures, such as typically lower than 20 bar). To use such conventional pressure vessel forms, such as type I or type II, for handling the storage pressures of CNG would involve thickening their walls, and modifying many other elements thereof, to increase their strength to an adequate level. However, that would mean that the pressure vessels are too large then to be accomodated within the strict size constraints for ISO modal containers, or too heavy to be useable within the ISO modal container since there are also strict weight limits for ISO modal containers, whereby it has been recognised that the maximum capacity of CNG within a ISO modal container is achievable only through the use of multiple smaller pressure vessels, each needing thinner walls than a single large pressure vessel. The present invention seeks to improve upon this prior art arrangement by increasing the storage capacity of CNG within an ISO modal container. In other words, the present invention attempts to maximise the available volumetric capacity of the ISO modal container.

The present invention achieves this by providing an ISO modal container for transporting CNG at a pressure in excess of 200 bar, comprising only a single pressure vessel therein, or a pressure vessel therein having an external diameter in excess of 1.8 m and a length in excess of 11 m, wherein the pressure vessel is a type 3 or type 4 pressure vessel, or another form of pressure vessel utilising a full composite overwrap and either a non structural metal liner or a non metal liner or a liner used purely for the process of manufacture, i.e. a removable liner.

Due to the form of the pressure vessel, it will be significantly lighter than a suitable equivalent type 1 or type 2 pressure vessel, i.e. one having the same volumetric capacity—the claimed invention preferably excludes type 1 and type 2 pressure vessels, thereby enabling substantially a maximised volumetric capacity for the ISO modal container to be achieved, and without exceeding the weight limits set by the Standards for ISO modal containers once loaded with CNG.

This arrangement is only achievable using the ligher forms of pressure vessel since strict weight limits apply to ISO modal containers due to the way in which they are handled—lorries have maximum tare weights, and cranes—used to lift them—have maximum safe working loads (SWLs).

Due to the weight restrictions, prior art arrangements for CNG transportation could not utilise the space available within the ISO Modal container effectively—the pressure vessels, when full, were considered to be too heavy, and certainly the largest size available for a single pressure vessel, if of type 1 or type 2, would not be as big as proposed by the present invention due to the necessary wall thicknesses and thus weight of the resulting pressure vessel.

Examples of prior art arrangements within the sort of volumetric sizes available to ISO Modal containers, i.e. that transportable on a lorry—a height of less than 2.5 m, a width of less than 2.5 m and a length of less than 12.5 m, and not exceeding 30.38 tonnes—are shown in FIGS. 18 to 21. These, however, are not examples of ISO modal containers, but instead trucks fitted with pressure vessels, potentially within removeable cages. An ISO modal container proposal for CNG transportation is only known from the prior art in respect of the arrangement shown in FIG. 22—by Trans Ocean Gas. This, however, has multiple smaller tanks, as discussed below.

Referring first to FIG. 18, there is shown a lorry fitted with one or more cages, filled with between 100 and 200 all steel (type 1) pressure vessels, each designed to contain CNG at conventional transportation pressures, e.g. in excess of 200 bar. However, each pressure vessel is necessarily small, whereupon the wall thicknesses required for containing that CNG is manageable in terms of fabrication and weight. This first prior art arrangement can carry up to 5,000 standard cubic metres of natural gas compressed therein (commonly referred to in the art as “5000 cubic meters of CNG”, and sometime using the unit “scf”—standard cubic feet, where 1 standard cubic meter=35.3146 scf).

Referring next to FIG. 19, a further arrangement of pressure vessels on the back of a lorry is shown. Again there are multiple pressure vessels—in this case nine, and they are permanently strapped down onto the bed of the lorry. Again these are all steel pressure vessels (type 1), and they offer a maximum storage capacity of between 5,000 and 6,000 standard cubic metres of CNG. As can be seen, the 4-3-2 stacking arrangement presents an inefficient space-utilisation if offered into the box-like shape of a ISO modal container (which has a square end shape).

Referring then to FIG. 20, a further prior art embodiment is shown, now using three larger pressure vessels, this time of a type 2 structure, i.e. with a fibre glass wrap surrounding the main steel-pipe (cylindrical) section. These tanks are lighter than the type 1 all-steel pressure vessels, but still will only permit the use of three pressure vessels within the given loading capacity of a lorry. The three pressure vessels nevertheless allow the lorry to transport 7,000 standard cubic metres of CNG, due to the vessels themselves being lighter, thereby freeing up weight capacity for CNG. However, the 2-1 stacked arrangement, like the arrangement in the previous example, is again inefficient for utilisation within the shape of an ISO modal container.

The largest current proposal for the market, in terms of load capacity, albeit one with loading and off-loading difficulties due to cooling/fracturing of the inlet/outlet, is by Lincoln Composites, and is known as the “Titan”. It provides four pressure vessels, each of a polymeric liner arrangement with a carbon fibre wrap therearound, i.e. type 4, but these still only achieve 8,000 standard cubic metres of CNG storage, and also it is not an ISO modal container proposal, but instead an arrangement carried on a lorry.

A similar arrangment has been proposed for an ISO modal container—see FIG. 22 (a proposal by Trans Ocean Gas), but it uses 8 pressure vessels, rather than 4, each having a volumetric containment of 3,000 litres, and thus a total storage capacity of 24,000 litres, or 312,000 scf of CNG (again approximatelyy 8,000 standard cubic metres of CNG). By having 8 pressure vessels, it was thought that offload and loading of CNG therein could be faster—8 inputs/outputs would be present.

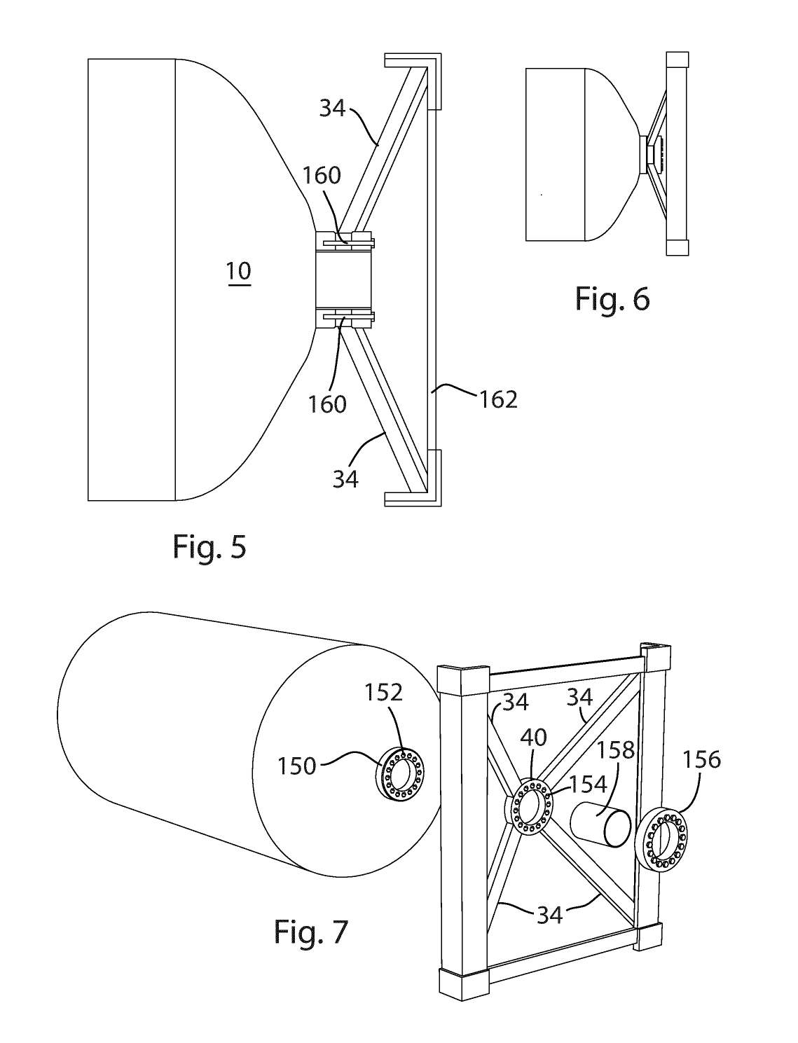

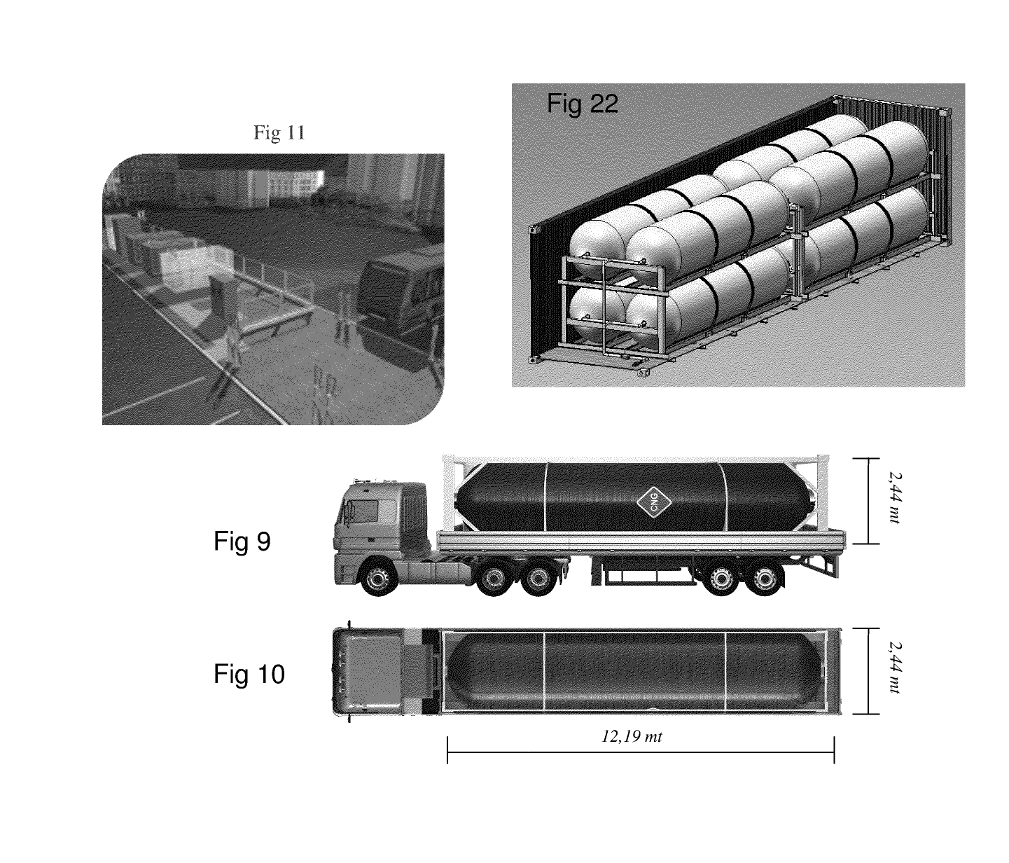

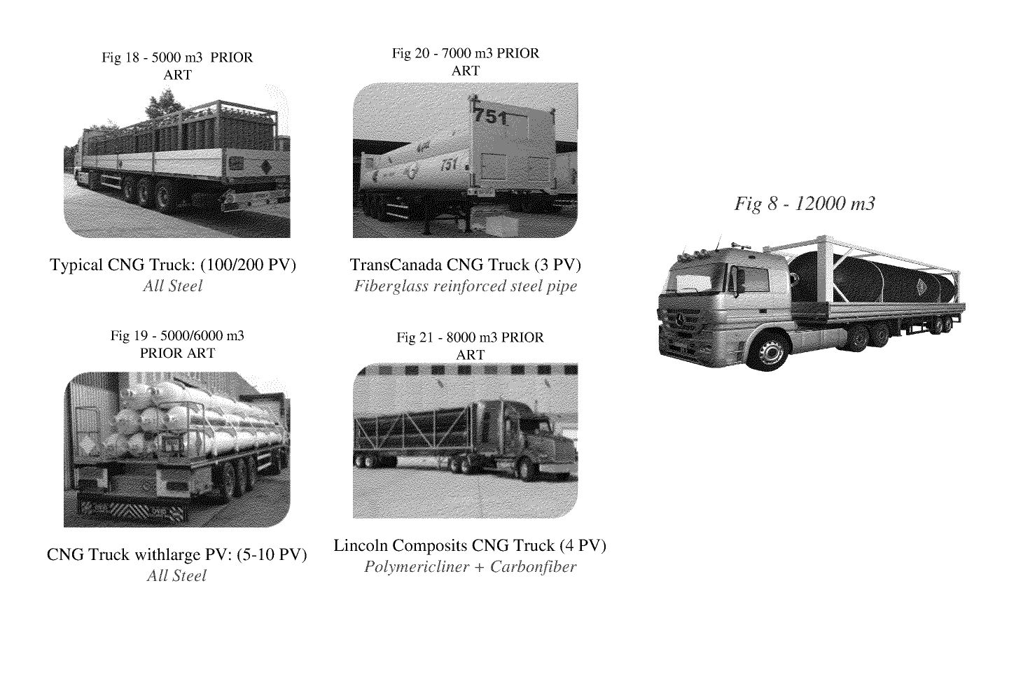

The present invention, however, instead proposes the arrangement shown in FIG. 8. In that embodiment approximately 11,200 standard cubic metres, or 398,000 scf, of natural gas (as CNG) can be stored within an ISO modal container by compressing it—it thus being CNG, or compressed natural gas.

The internal volume of the pressure vessel is about 35 cubic meteres—achievable since the arrangement required by the present invention involves a single tank within the ISO modal container—this provides an improved volumetric space utilisation without compromising pressure vessel strength—the latter could occur if one was to make the vessel non-cylindrical, although that would also be an option within the present invention.

The present invention, in these illustrated examples, therefore achieves a 30 to 50% increase in the volumetric capacity of CNG stored within the ISO modal container (12000 standard cubic meters) compared to that currently proposed in the art for transport on lorries (8000 standard cubic meters), yet while still achieving compliance with the relevant Standards for ISO modal containers.

To resolve the offload/loading issue the present invention also provides an inlet/outlet of a larger diameter than that previously proposed—preferably suited for connection to 12 inch or 30 cm pipework, and preferably having no less than a 20 cm internal diameter.

According to the present invention, therefore, there also provided an ISO modal container for CNG transportation, comprising just the one pressure vessel, the pressure vessel having an inlet/outlet for loading/unloading CNG therefrom, wherein the inlet/outlet has an internal open diameter of no less than 20 cm.

Preferably the anchorage structure for securing the pressure vessel within the ISO modal container comprises pairs of plates, rings or collars provided inside the container for connecting the main body of the pressure vessel (i.e. normally their central, cylindrical part) to the containers.

If plates are used, they are generally perforated so as to make the anchorage structure lighter.

These anchorage structures can have various configurations, all of which are designed to support the cylindrical central body of the pressure vessels in place inside the ISO modal container. For example, more than two such plates, rings, collars—or alternative brackets—can be provided along the central cylindrical part of the pressure vessels. Further, “cages” comprising a number of supporting members can be provided around the pressure vessel's central cylindrical body.

In these arrangements, therefore, supporting the pressure vessel in an ISO modal container has been achieved in a similar manner to that used for transporting large pipes, i.e. supports sized to support a generally cylindrical member.

Occasionally the pressure vessels may have to be removed from the containers, e.g. for maintenance operations or repairs. To do this, the pressure vessel can slide out through the plates. Otherwise, the pressure vessel remains assembled in the container for long periods of time and for many cycles of loading and offloading, i.e. without the vessels being removed from their anchorage structures.

With these arrangements, the central cylindrical body of the pressure vessel is the structural part of the pressure vessel that is secured by the plates or rings. With CNG pressure vessels, however, those areas are areas that experience very high internal force loadings due to the high internal pressure of CNG. The action of the external support forces on the cylindrical bodies of the vessels due to the above plates, rings or brackets would therefore undesireably be exerted upon the pressure vessels in addition to the internal forces. This can result in excessive stresses within the cylindrical section of the pressure vessel's walls. Also this stress is usually concentrated in the most mechanically loaded portion of the pressure tank structure: the cylindrical or “hoop” section.

Furthermore, as the pressure vessels are constrained radial-symmetrically around circumferential cross sectional portions of their longitudinal bodies, the supports of the prior art also can act as obstacles to cyclical “breathing” of the pressure vessels when they are being filled and emptied. This breathing occurs because during loading and offloading, large internal pressure gradients are present—the initial pressure is high, and the exit pressure is significantly lower than that—and those pressure gradients can drive cycles of radial expansion and contraction through a vessel's body as one or more of the vessels is loaded or unloaded.

Accordingly, it is a further objective of the present invention to provide an alternative supporting system.

One solution is to provide padded, compressible or resilient supports, whereby the “breathing” of the pressure vessels can be accomodated. More preferaby, however, where the pressure vessel comprises a main longitudinal portion and two end caps, each at respective ends of the main longitudinal portion, the container comprises a frame body for accommodating the pressure vessel therein, said frame body comprising two ends connected by longitudinally extending members or beams, and an attachment for holding the pressure vessel in place inside the frame body, wherein the attachment is configured for supporting the pressure vessel generally at, or in cooperation with, at least one of the end caps of the pressure vessel.

The longitudinal portion of the pressure vessel, once fitted within the frame body, may extend substantially parallel to the longitudinally extending beams of the frame body.

Preferably the two ends of the frame body are end sides or end frames.

The present invention implements a form of “suspension” structure, with the pressure vessel suspended at at least one of its ends inside the container. This configuration allows for improved (or more freedom for) “breathing” of the pressure vessel (radial expansion and contraction due to the volumetric expansion that composite pressure tank structures allow, which breathing will occur mainly along its central longitudinal body portion, which is usually cylindrical). As a result, “breathing” is advantageously less constrained by the supports of the pressure vessel by means of the present invention, as compared to the supports of the prior art.

Further, such a design of ISO modal container is likely to allow a better distribution of weight on the supports in comparison to the prior art, since the (heavy) pressure vessels are likely to be better balanced, or less susceptible to longitudinal rocking, by being supported at their ends rather than along their central bodies, due to the more distant positioning of the support at the neck away from the centre of mass of the vessel.

Further, CNG pressure vessels supported in accordance with the present invention are less likely to undergo axial displacement relative to the containers, and, therefore, be less likely to be accidentally displaced during the operations of loading and unloading of CNG when external pipes are connected to the pressure vessel inside the container, or when the carrier ships pitch in rough sea. This is because the size of the cross section of the pressure vessel at the end caps is smaller than the size of the cross section of the pressure vessel at its main longitudinal body, whereby relative displacement between the support and the pressure vessel is restricted. Accordingly, if the pressure vessel is supported at least at one end, it will be more difficult or impossible for the pressure vessel axially to slide or become displaced in its supports unless the supports are damaged or disassembled.

Furthermore, since the end caps of the pressure vessel are less stressed by the action of the internal pressure forces compare to the main body, due to the lower diameter thereof, the caps are more likely than the pressure vessel's main body to have spare capacity to withstand external supporting forces, whereby the neck is a good location for at least one of the supports.

If at least one of the end frames is generally planar in shape, such as a rectangular or square end frame, the attachment may comprise an arm or a supporting membrane or web which extends from the frame body substantially parallel to said end frame of the frame body.

Further, the arm, membrane or web may extend from one of the end frames of the frame body, and lay generally coplanar with the end frame.

Since a corner has a relatively high flexural rigidity, the arm or supporting membrane or web may extend from a corner of the end frame.

The arm, membrane or web might be arranges so as not to penetrate the internal space of the container. In other embodiments, the arm, supporting membrane or web may extend internally, i.e. with penetration into the internal space of the container.

The arm, supporting membrane or web supports or connects the frame body of the container with one of the end caps of the pressure vessel.

Preferably, the attachment comprises an arm or a supporting membrane or web which extends into the internal space of the container, into a portion of the internal space available between the end frame of the container and the pressure vessel. This space, into which the arm or supporting membrane or web may extend, can alternatively be defined as the space that would be swept by a longitudinal projection of the container's body over an end frame of the container.

In embodiments comprising an arm, the arm may extend from the frame body to form an angle with a plane perpendicular to the longitudinal direction of the frame body, or a plane defined by one of the end frames of the frame body of the container if one of the end frames is generally planar, so that, if the frame body is seen from one side, perpendicularly with respect to its longitudinal direction, the arm extends out-of-plane from said perpendicular, reference plane.

An acute angle may be formed between the arm and said reference plane. The acute angle can be in the range between 1 and 30 degrees, and preferably can be in the range between 10 and 20 degrees.

The arm may extend from a corner region of the frame body, which, because of its inherent relatively high rigidity, is particularly suited to function as an anchorage location on the frame body. In particular, the arm may extend from a corner region located on one of the end frames of the frame body.

Preferably, the arm, or at least a portion thereof, is straight or extends substantially along a straight line. The overall length of the arm may be equal to, or less than, half of the length of a notional geometrical diagonal cutting across the shape of one of the end frames of the frame body.

This is particularly appropriate when they have the geometrical shape of a rectangle or a square.

The arm may be configured to extend from the frame body to point towards a central longitudinal axis of the frame body, such as the pressure vessel's central axis.

The arm may comprise a flange, or a flanged portion, and the flange or flanged portion (i.e. these rather than the arm itself) may be configured to support the pressure vessel at, or in cooperation with, the end cap of the pressure vessel (for example, the flange may have holes for bolted connections).

The flange or flanged portion may have an inner side, i.e. a side facing internally with respect to the volume defined by the container's frame body, and said arrangement or configuration to support the pressure vessel may be provided on said inner side of the flange or flanged portion.

In preferred embodiments, the inner side of the flange of the arm can be configured to be attached to an end boss of the pressure vessel (if an end boss is provided on at least one of the end caps of the pressure vessel). Such an arrangement may require a custom configuration, and such a configuration will depend on the geometry and size of the end boss provided. After all, different types of end boss can be used on CNG pressure vessels.

The flange or flanged portion may have an outer side, i.e. a side that faces outwardly with respect to the internal space of the container, and said outer side can be provided with attachment features for attachment of an external element, such as an additional flange, or flanged pipe or the like. This arrangement is useful in operations such as loading and offloading of CNG, for example when there is a need to connect a loading or offloading pipe to the pressure vessel being supported inside the frame body of the container. In these configurations, the flange effectively acts as an interface member for interfacing or facilitating a connection between, for example, a pipe and the pressure vessel.

The flange may have sealing means for establishing a fluid connection between the internal volume of the pressure vessel and the pipe.

The container may have a cover or enclosure as part of, or around, the frame body.

If the container does not have an enclosure on the end side of the container opposite the inlet of the pressure vessel, loading and offloading of CNG are facilitated.

If the container is at least partially in communication with the external environment, the container will be safer because any leaking CNG is readily dispersed in the environment. However, some applications may require at least partial enclosure of the internal space of the container.

The attachment and one end frame of the frame body of the container may define an empty space generally located therebetween. That space can be used to allow insertion of a pipe into the container for loading and offloading CNG, or it can be used to provide attachment means between an external pipe network and the internal pressure vessel.

The ISO modal container may have a volume of empty space defined internally of the frame body between the plane of one of the ends and an or the attachment. This can be for the above reason or the gap or space can simply be useful for inspection purposes—there will typically be at at least one end of the each pressure vessel a sealable opening (a manhole) typically having an 18 inch, or even a 24 inch diameter. The opening is an inspection opening.

Given that a very common geometry of pressure vessels is a cylinder with dome-like end caps, the flange or flanged portion can be generally annular or ring-shaped, to mate or match with the geometry of the end cap of the pressure vessel, in order to provide a radial-symmetrical support or connection.

Preferably, the attachment comprises one or more further such arms. Multiple arms can allow the weight of the pressure vessel to be distributed between the multiple arms.

Preferably, the arms are substantially symmetrically disposed around the longitudinal axis of the frame body (and of the pressure vessel, if the pressure vessel is present). Symmetrical arrangements will typically cause the weight of the pressure vessel to be more equally distributed between the various arms.

If the attachment comprises a total of four arms (which are particularly suitable if the frame body and the container have the general shape of a cuboid or prism, e.g. with square or rectangular end frames), then each arm might be provided to extend from one respective corner of one of the end frames of the frame body.

The flange or flanged portion, which—if present—is typically the component that is to support the pressure vessel, or the component that is to be connected to the pressure vessel, can be connected to the arms to enable an interconnection between the four arms.

Alternatively, each arm can have its respective flange or flanged portion, and the separate flanges or flanged portions can be configured individually for supporting, or for connection to, the pressure vessel's end dome or end boss (if one is present).

If a further such attachment is provided, then the pressure vessel can be supported at each of its ends, i.e. at each of the end caps, by a respective one of the attachments.

According to a further aspect of the present invention, there is provided an anchorage structure for anchoring a CNG pressure vessel to an ISO modal container, the ISO modal container having a frame body as defined above, the anchorage structure comprising fastening means for fixing the anchorage structure to the frame body of the ISO modal container, and arranged so that, in use, the anchorage structure assembled to the ISO modal container forms an ISO modal container as defined above.

According to a further aspect of the present invention, there is provided a system for handling, storing and transporting CNG comprising: an ISO modal container as above defined, and a pressure vessel arranged to be supported inside the ISO modal container, and arranged for storage and transportation of CNG.

The present invention also envisions a method of transporting CNG comprising filling ISO modal containers as defined above, and loading the ISO modal containers onto a ship.

The present invention also provides a ship loaded with ISO modal containers as defined above.

These and other aspects of the present invention will now be described, purely by way of example, with reference to the accompanying drawings in which:

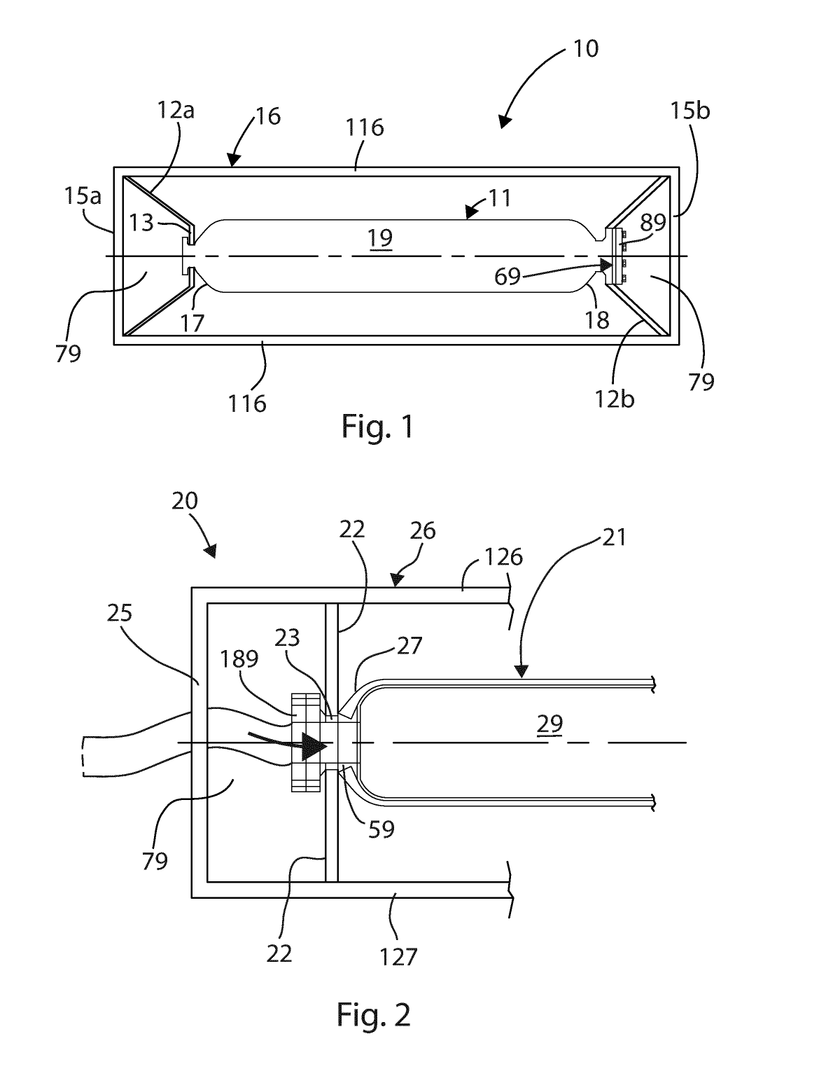

FIG. 1 is a schematic side view of an ISO modal container for transportation of CNG in pressure vessels according to an embodiment of the present invention;

FIG. 2 is a schematic partial side view of an ISO modal container for transportation of CNG in pressure vessels according to another embodiment of the present invention;

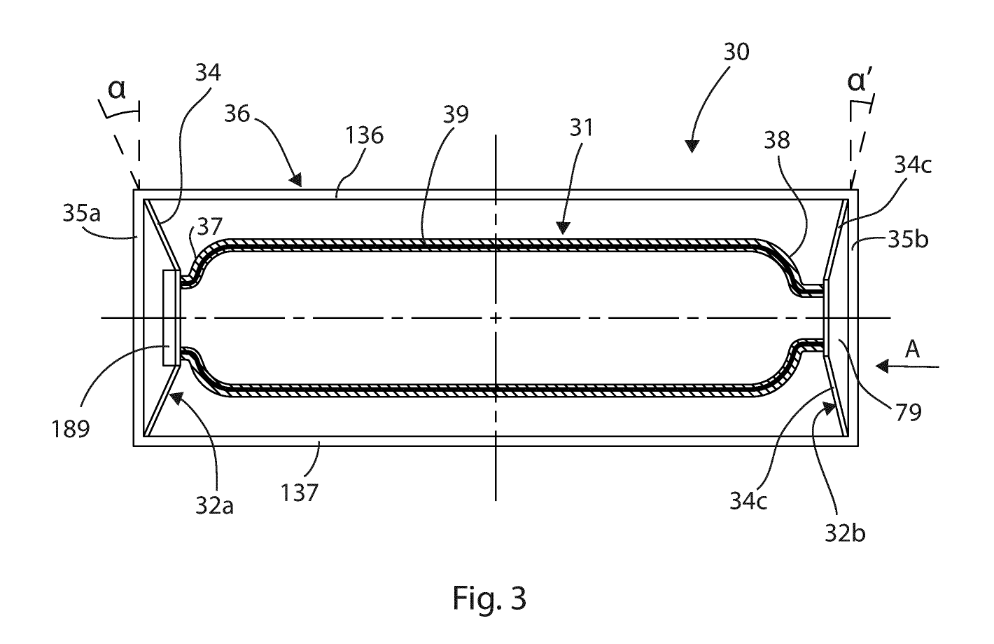

FIG. 3 is a schematic side view of an ISO modal container for transportation of CNG in pressure vessels according to a third embodiment of the present invention;

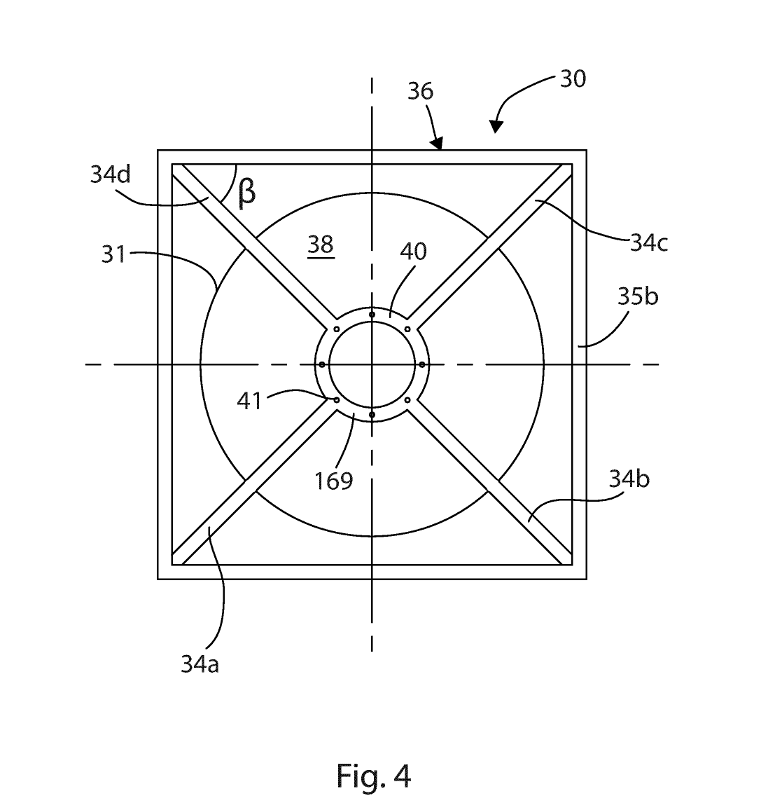

FIG. 4 is a schematic front view from side “A” of the embodiment of FIG. 3;

FIG. 5 is a close up schematic of a further embodiment;

FIGS. 6 and 7 show further views of that further embodiment;

FIGS. 8 to 10 show a lorry carrying an ISO modal container in accordance with the present invention;

FIG. 11 schematically shows a tank refuelling station;

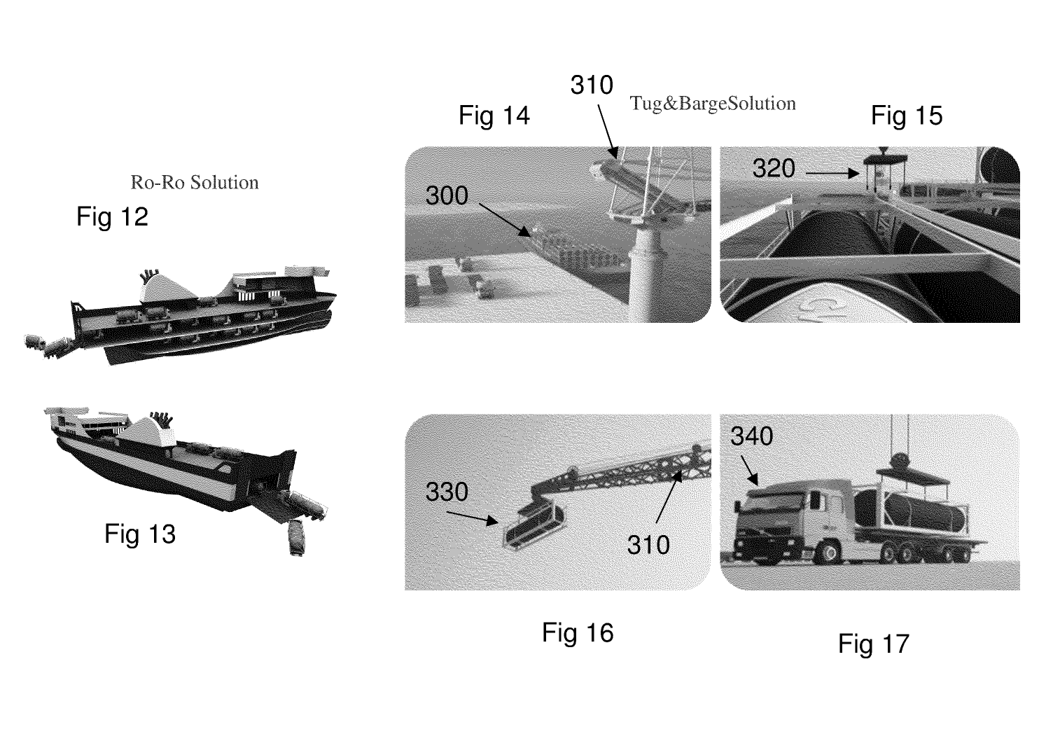

FIGS. 12 and 13 show a ship for a roll-on roll-off (roro) solution utilising lorries carrying an ISO modal container of the present invention;

FIGS. 14 to 17 show dockside loading and unloading arrangements for ISO modal containers of the present invention; and

FIGS. 18 to 22 show prior art arrangements as discussed above.

The figures are not to scale.

Referring first of all to FIG. 1 there is shown an ISO modal container 10 for storage and transportation of CNG within a CNG pressure vessel 11 thereof. The pressure vessel 11 is formed by a main longitudinal portion 19 that extends between two end caps 17, 18, which together define an internal volume of space in which the pressurized CNG is stored.

The container 10 has a structural frame 16 for supporting the pressure vessel 11 in the inner space defined by the structural frame 16.

The frame 16 has two ends or bases (end sides or end frames) 15a, 15b opposite the end caps 17, 18 of the pressure vessel 11, as shown in FIG. 1. Horizontal structural members or beams 116, 117 connect the two ends 15a, 15b of the frame 16.

In this embodiment, the frame 16 has the geometrical shape of a cuboid or rectangular prism, with square or rectangular bases 15a, 15b. The frame is therefore a form of “box”.

The box is shown in FIG. 1 to be extending horizontally, which is a common configuration for transportation of ISO modal containers 10, e.g. on boats. As such it is longer than it is tall, and likewise is can be wider than it is tall, although a square shape is also anticipated, as shown in FIG. 4.

The ISO modal container 10 is essentially an open structure, i.e. a “wire-frame” structure, formed of beams, such as steel girders or angle iron, and the frame is thus made of a series of structural members 15a, 15b, 116, 117 that define the shape of a prism, box or cube, in this embodiment having a pair of opposing square bases 15a, 15b. This shape is especially common for ISO modal containers. However, different shapes might be possible, within the scope of the invention, and relevant Standards will define the appropriate sizes for these variants.

The inner space defined by the frame 16 of the container 10 is not enclosed in this embodiment. This is an advantage in terms of safety and operability in CNG applications: any leaked CNG can readily disperse into the environment, and the pressure vessel 11 can be readily accessed for loading and offloading the CNG therein, and also to facilitate inspection or maintenance.

In alternative embodiments, however, at least some of the sides of the container might have panels, covers, screens or the like, provided to provide at least a partial “fuselage” around the container 10. These “panels” could provide a degree of protection for the pressure vessel 11 in applications where that was required.

The “panels” might be permanent or removeable, or could even be a temporary cover, such as a fabric sheet, for minimising direct sunlight exposure, or to minimise exposure to sea wash (i.e. spray from waves at sea).

At least one attachment 12a, 12b is provided inside the frame 16 for holding the pressure vessel 11 in place, i.e. to prevent or minimise relative displacement (e.g. translations or rotations) of the pressure vessel with the frame 16. Dynamic motion of the pressure vessel on its supports is preferred still to be allowed, such as vertical or axial vibrations or “bouncing” of the pressure vessel 11 in the frame 16, but significant movements are restricted so as to prevent the pressure vessel from moving beyond the safety areas within the ISO modal container—a space is required around the pressure vessel to ensure that damage cannot occur thereto when the ISO modal containers are stacked or loaded/unloaded from the ship.

In the embodiments illustrated in FIGS. 1, 2, 3 and 4, two types of attachment 12a, 12b, 25, 35a, 35b are illustrated. They are adapted to support respective end caps 17, 18, 27, 37, 38 of the pressure vessels 11, 21, 31 illustrated. These are preferred configurations, although one end of the pressure vessel 11, 21, 31 might be supported in an alternative manner, for example in accordance with the prior art, with one perforated plate having a central opening for supporting thereon the main central body 19, 29, 39, of the pressure vessel 11, 21, 31.

The longitudinal portion 19, 29, 39 of the pressure vessel 11, 21, 31, as it can be seen in FIGS. 1, 2, 3 and 4, is configured within the frame 16, 26, 36 to extend parallel to the primary longitudinal beams 116, 117, 126, 127, 136, 137 of the frame 16, 26, 36 of the container 10, 20, 30, i.e. the edge members thereof.

The attachments 12a, 12b, 25, 35a, 35b are configured for supporting the pressure vessel at the end caps 17, 18, 27, 37, 38 of the pressure vessel 11, 21, 31.

In FIG. 1, the attachments 12a, 12b are provided by substantially rigid supporting members made of a metallic material, such as steel. Attachment 12a supports directly a neck portion of the left end dome 17 of the pressure vessel 11. A vertical collar 13 is then provided around the neck of the vessel. The right-hand side attachment 12b is provided instead with a flange 69 for connection to the right end dome 18 of the pressure vessel 11.

The flange 69 functions as an interface between the pressure vessel 11 and an external member 89 that can be connected via the flange 69 to the pressure vessel. In FIG. 1, the external member is represented as a bolted-on cap 89, but it could be, in other embodiments, a pipe for loading or offloading CNG.

The attachment membranes 12a, 12b are generally inwardly extending, as can be seen in FIG. 1, with them defining a frame arrangement having a concavity when looked at from the outside of the frame. In other words, the membranes 12a, 12b penetrate inwardly into the inner space delimited by the outer frame 16 of the container 10. Seen from an end, however, the membranes take the form of an “X”. See, for example, FIG. 4.

In the embodiment shown in FIG. 2, however, the attachment (again formed of one or more membrane 22) is planar. It has a collar 23 which is attached directly to an end-boss 59 of the pressure vessel 21.

In alternative embodiments, the membrane could still be planar but it could be provided across one of the end bases 25 of the container 20. That can be imagined by translating the membrane of FIG. 2 along the longitudinal direction of the container until it overlaps with the end base 25.

The attachment such as the planar membrane 22 could be integrated into an embodiment in which a panel or screen covers one end side of the container 20. In such a configuration, the end cap of the pressure vessel would reach the end frame 25 of the pressure vessel, and no space 79 would be defined between the pressure vessel 21 and the outer base 25, inside the container 20. This configuration allows an optimised use of the internal space of the frame 26 of the container 20 (more CNG transported in the given space, inside the ISO modal container). However, the end cap might be more susceptible to damage during loading and unloading of the ISO modal container onto or off the ship since the space 79 is provided to reduce the risk of such damage.

In FIG. 2, the collar 23 of the membrane 22, for attachment of the end cap 27 of the pressure vessel 21 to the frame 26 of the container 20, is configured similarly to the flange 69 of FIG. 1. It is for attachment to an external CNG loading pipe 189.

In other embodiments, the membranes of FIGS. 1 and 2 can be replaced by alternative supporting structures, including perforated plates, brackets or the like.

In preferred embodiments, the invention comprises at least one arm for supporting the pressure vessel inside the container. An embodiment of ISO modal container comprising supporting arms can be seen in FIGS. 3 and 4.

In FIGS. 3 and 4, each end cap 37, 38 of the pressure vessel 31 is connected to the frame 36 of the container 30 by means of four arms (together labelled 34) extending each 34a, 34b, 34c, 34d from a corner of one of the bases 35a, 35b or end frames of the container 30.

FIG. 4 shows an end view of the ISO modal container showing all the supporting arms 34a, 34b, 34c, 34d connecting one of the end domes 38 of the pressure vessel 31 to one of the end frames 35b of the container 30.

FIG. 3 shows the two angles α and α′ that are formed by the arms with respect to vertical planes defined by the respective end bases 35a, 35b of the container's frame 36 from which the arms extend. It is not mandatory that the two angles α and α′ be the same. However, in preferred embodiments said angles are closely similar to one another.

When the two angles α and α′ tend towards zero, the arms 34 tend to overlap, or lie within, with the plane of the end frames 35a, 35b. When the angles α and α′ increase, the arms 34 tend to extend further into the internal space of the frame 36, thus deepening the concavity of the frame formed by the arms, as viewed from outside the frame.

Optimal angles for the two angles α and α′ are believed to be in the range of between zero and 60 degrees. Preferred Angles α and α′ may be between 10 and 45 degrees, and most preferably, particularly on containers carrying a pressure vessel with a diameter of more than 1 m, angles of perhaps between 10 and 20 degrees are useful. The angle, however, is preferably defined or chosen such that the end domes of the pressure vessel 31 are both contained inside the constraints of the frame of the container 30, and close to or adjacent to the end bases 35a, 35b of the container's frame, but preferably while still leaving enough space for any external components 189 to be attached to the pressure vessel in the available end space 79.

Referring, therefore, to FIGS. 5 to 7, an arrangement where the angle is closer to 30° is shown. The illustrated angle is actually about 28°. This embodiment will be further described below.

Bear in mind too that arms may extend from sidewalls or box edges as well as from (or instead of) the corners of the boxes. Further, all arms may not be of the same length.

Further, although the arms are illustrated to be generally straight, they can instead be curved or profiled in other ways. By being straight, however, they are best adapted to resist buckling loads during the transportation of the pressure vessels.

The cross section of the arms, and other frame members, are typically L shaped, or I or H shaped or U or C shaped, since they are typically used for such frame designs—their strength properties under bending, torsion, compression and tension are well known. There may be various combinations of such shapes, as required to ensure the ISO modal container meets any required strength requirements under the relevant Standards.

FIG. 4 shows four arms 34a, 34b, 34c, 34d and a flange 169 forming the right-hand attachment 32b for the container 30 of the third embodiment.

Seen from an end as in FIG. 4, each arm is a straight member projecting towards the central longitudinal axis of the pressure vessel 31 and of the container 30.

Geometrically, seen from one end, each arm is provided diagonally with respect to the square end base 35b from which the arms 34 project.

Each arm is attached to a corner of the end base 35b.

The arms 34a, 34b, 34c, 34d are interconnected by a flange 169, which has an inner side (facing into the page) for interfacing and connecting with the pressure vessel 31, and an outer side 40, facing out of the page, configured for connection to an external element, such as a CNG loading pipe, or a clamp therefor, by any suitable attachment means 41.

In this embodiment, the arms and flange are integrally formed, or are welded together. For example, they might either be cut from plate-stock or be fabricated from a ring and four angle irons.

The angle β formed between each of the arms and its adjacent horizontal member of the frame base 35b, as shown in FIG. 4, can vary dependent upon the design of the arms and the design of the flange, and dependent upon the overall shape of the ISO modal container. After all, the flange 169 may have a different shape to that shown in FIG. 3. Likewise, the arms might not be straight, or they may have tapering sides,. Yet further, the end of the frame of the container might not be square. Accordingly, the angles β can be greater or smaller than that shown, depending on the location of the attachment of the arms 34 to the flange 40, and on the shape of the container, and on the location of the end cap relative to the container, and on the shape of the arms. In this illustrated embodiment, however, the angle β is about 45 degrees.

In this embodiment, angles β down to perhaps 20 degrees might also be desired, and that might be achieved by changing the shape of the flange 40 so as to have additional extensions, e.g. in the vertical direction. This alteration could make the concavity defined by the arms more open so that access space for making a connection of the end of the pressure vessel to a CNG load or unload pipe is more generous.

As for securing the ISO modal container to the vehicle for transporting the container between locations, standard securement points can be provided in accordance with the relevant Standards. A disclosure of those securement points is not relevant to the present invention, whereby it is not provided herein.

Referring next to FIGS. 5 to 7, the further embodiment is disclosed. This again has four arms 34 and a flange 40, and it is also capturing the neck area of the vessel 10. However, the vessel has an opening 150 with a plurality of bolt-holes 152 extending in a ring around the opening 150. Those bolt holes correspond with bolt holes 154 in the flange 40. There is then a washer cap 156 with bolts for strapping down the vessel relative to the flange 40 and a tube 158 fits through the arrangement to align the elements together during the connection process.

Two of the bolts 160 are shown in FIG. 5.

The arms 34 in this further embodiment are straight but angled out of the plane of the end frame 162 at an angle of about 28°. This allows the end of the vessel, when mounted, to be within the containment of the ISO modal container, so as to provide access to the end, e.g. even when the pressure vessel is loaded on a ship.

It is also clear that although specific frame arrangements are disclosed, which frame arrangements have anchorage structures for securing a pressure vessel within the ISO modal container that is illustrated, adapting existing ISO modal containers so as to have such anchorage structures extending from their sidewalls or frame corners/edges is also within the scope of the invention, i.e. so as to create further embodiments of ISO modal containers according to the present invention. Accordingly, the above description of the anchorage elements 12a, 12b, 22, 32a, 32b applies equally to equivalent anchorage elements that can be produced independently of the outer frame of the ISO modal containers, whereby they can be retro-fitted to existing ISO modal containers, e.g. as a kit of parts.

As shown in FIGS. 1 to 7, the pressure vessels 11, 21, 31 are suspended in the ISO modal containers 10, 20, 30 by their end caps by means of the specifically-built attachments 12a, 12b, 22, 32a, 32b. As a result, the main longitudinal bodies 19, 29, 39 of the pressure vessels have a radially unconstrained space along their lengths for allowing breathing of the pressure vessel, i.e. expansion and contraction under the action of the varying internal pressure forces during loading and unloading of CNG, and also the inevitable expansion anyway as a result of the static pressure one loading is completed—the transportation pressure for CNG is typically around 250 bar.

It will also be appreciated that the rigidity of the attachments 12a, 12b, 22, 32a, 32b will determine the extent to which the pressure vessels 11, 21, 31 can vibrate axially and/or radially in the ISO modal containers 10, 20, 30 when the containers are, for example, moved around the ships, or during transportation at sea. There is no requirement for them to be very rigid. Indeed, a degree of resilience is beneficial since it can cushion the pressure vessel in the event of adverse loading conditions (e.g. rough sea conditions, and the impacts of large waves either onboard, or against the ship's hull). However, the arrangement of the attachments 12a, 12b, 22, 32a, 32b preferably substantially restrict the amount of axial displacement achievable by the pressure vessels on their supports 12a, 12b, 22, 32a, 32b.

Axial rotation of the pressure vessels might also be resisted by the attachments/flange, although such rotation is generally not undesireable since the freedom to undertake such rotation is likely to ensure that expansion of the pressure vessel's diameter is not resisted.

Compared to the prior art, the present invention, therefore, provides at least an alternative, advantageous ISO modal container, an anchorage structure therefor and a system comprising an ISO modal container and a pressure vessel, for storing, transporting and handling CNG.

The pressure vessel typically is for CNG, but it might be for carrying a variety of gases, such as raw gas straight from a bore well, including raw natural gas, e.g. when compressed—raw CNG or RCNG, or H₂, or CO₂ or processed natural gas (methane), or raw or part processed natural gas, e.g. with CO₂ allowances of up to 14% molar, H₂S allowances of up to 1,000 ppm, or H₂ and CO₂ gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state, and other impurities/species.

Referring now to FIGS. 8 to 10, a lorry carrying an ISO modal container of the present invention is shown. The lorry comprises a cab at the front and a trailer at the back, the trailer carrying the ISO modal container with the single pressure vessel secured therein—the securement may be as shown or discussed above.

The ISO modal container shown has dimensions of approximately 2.44 metres by 2.44 metres by 12.19 metres. This is approximately 8 by 8 by 40 feet. The maximum allowable weight, when loaded, is slightly above 30 tonnes, e.g. 30.38 tonnes in some cases.

Since CNG has a relatively low density compared to liquids (typically 200 kg per cubic meters), the mass of the empty pressure vessel combined with the weight of the frame of the ISO modal container form a substantial part of the weight of the loaded ISO modal container as a whole. It is therefore this low load mass that allows such a large pressure vessel to be provided within the ISO modal container without exceeding the above mentioned maximum allowable weights. To fill it with a liquid (i.e. a more dense substance), e.g. water, would cause it to exceed allowable weight limits, whereby the provision of such a large pressure vessel is unexpectedly useable. After all, the carriage of liquefied gases typically has not been achievable in such a large pressure vessel within an ISO modal container. Therefore such an arrangement has not previously been considered achievable.

As can be seen, each end of the pressure vessel has an end cap. One end is for loading and unloading and the other end is for inspection purposes. For loading or unloading, an inlet/outlet is provided having an internal diameter of no less than 20 cm and preferably approximately 12 inches (30 cm). This can be connected, in use, to a supply/distribution pipe for loading or offloading the contents of the pressure vessel.

The other end—the inspection end—is preferably provided in the form of a manhole with an opening diameter of at least 18 inches (45 cm), and more preferably 24 inches (60 cm) so as to allow human inspection to be carried out inside the pressure vessel. This is a preferred option to allow regular servicing to be carried out inside the pressure vessel, and is only achievable due to the size of the pressure vessel permitting a person to climb inside with equipment, and due to the end cap being large enough to accommodate such a manhole.

Preferably the pressure vessel has an internal diameter of no less than 1.8 metres and an internal length of no less than 11 metres.

Referring next to FIGS. 12 and 13, a roll-on roll-off solution is provided utilising the lorries described above. As can be seen, a ship 200 is provided having multiple decks, each adapted to accommodate the height of a lorry with an ISO modal container mounted on the back thereof. To load the ship 200, the lorries 210 drive onto the ship 200 in a conventional manner, as in vehicle ferries. Then at the other end they can drive off.

Instead of this roll-on roll-off solution, the present invention can also be used in a tug and barge or conventional container loading/off-loading process. A ship or barge 300 pulls up alongside the dock, near a crane 310, which crane has a lifting rig 320—see FIG. 15. That lifting rig, as per standard, has four depending hooks that can latch onto standard attachment points provided on the ISO modal container. The crane 310 can then lift the ISO modal container 330, as shown in FIG. 16, for loading it onto a lorry 340 as shown in FIG. 17. In place of the lorry, it might be a train.

Due to the increased volume capacity of the ISO modal containers of the present invention, the transportation of CNG via the ISO modal container process becomes a viable option since sufficient volume of CNG can be transported in each ISO modal container to make the expense thereof commercially worthwhile.

Further, as can be seen in FIG. 14, a ship can transport many such ISO modal containers—as illustrated approximately 50. The transportable volumes are therefore now substantial, and greatly more than that achievable with the prior art arrangements of FIGS. 18 to 22, wherein each lorry only carries a smaller volume of CNG.

The increases in capacity leads to increases in efficiency, and this therefore provides sufficient motivation to commercialise this solution.

The present invention has been described above purely by way of example. Modifications in detail may be made to the invention within the scope of the claims appended hereto.

1. An ISO modal container for transporting CNG at a pressure in excess of 200 bar, comprising only a single pressure vessel therein, or a pressure vessel therein having an internal diameter in excess of 1.8 m and a length in excess of 11 m, wherein the pressure vessel is a type 3 or type 4 pressure vessel, or another form of pressure vessel utilising a full composite overwrap and either a non structural metal liner or a non metal liner or a liner used purely for the process of manufacture.

2. An ISO modal container according to claim 1 comprising an inlet/outlet for loading/offloading CNG from the pressure vessel having an internal diameter of no less than 20 cm.

3. An ISO modal container for CNG transportation, comprising just one pressure vessel, the pressure vessel having an inlet/outlet for loading/unloading CNG therefrom, wherein the inlet/outlet has an internal diameter of no less than 20 cm.

4. (canceled)

5. (canceled)

6. An ISO modal container according to claim 1, the pressure vessel comprising a main longitudinal portion and two end caps, each at a respective ends of the main longitudinal portion, the container comprising a frame body for accommodating the pressure vessel therein, said frame body comprising two ends connected by longitudinally extending beams, and an attachment for holding the pressure vessel in place inside the frame body.

7. An ISO modal container according to claim 6, wherein the attachment is configured for supporting the pressure vessel generally at, or in cooperation with, one of the end caps of the pressure vessel.

8. An ISO modal container according to claim 6, wherein once the pressure vessel is fitted within the frame the attachment connects one end of the frame body to one of the end caps of the pressure vessel.

9. An ISO modal container according to claim 6, wherein at least one of the ends of the frame body is generally planar, and the attachment comprises at least one arm extending from the frame body substantially parallel to the at least one planar end frame.

10. (canceled)

11. (canceled)

12. (canceled)

13. An ISO modal container according to claim 9, wherein the at least one arm extends from a corner region of the frame body.

14. (canceled)

15. An ISO modal container according to claim 9, wherein the longitudinal portion of the pressure vessel is substantially parallel to the longitudinally extending beams of the frame body of the container and wherein the at least one arm extends from one end of the frame body substantially towards a central longitudinal axis of the frame body and of the pressure vessel.

16. An ISO modal container according to claim 9, wherein the at least one arm has a flange or flanged portion and wherein said flange or flanged portion is arranged for supporting the pressure vessel.

17. An ISO modal container according to claim 16, wherein the flange or flanged portion has an inner side and an outer side and wherein the inner side is arranged for supporting the pressure vessel.

18. An ISO modal container according to claim 17, wherein the outer side is arranged for attachment to an external component.

19. An ISO modal container according to claim 16, wherein the flange or flanged portion is generally annular.

20. An ISO modal container according to claim 16, wherein the flange or flanged portion is configured for attachment to an end boss of the pressure vessel.

21. An ISO modal container according to claim 16, wherein the attachment comprises two or more arms.

22. An ISO modal container according to claim 21 wherein at least two of the at least two arms are connected to the flange or flanged portion.

23. An ISO modal container according to claim 21, wherein the arms are substantially symmetrically disposed around a longitudinal axis of the pressure vessel.

24. An ISO modal container according to claim 21, wherein the arms are substantially symmetrically disposed around a longitudinal axis of the ISO modal container.

25. An ISO modal container according to claim 21, wherein at least one of the ends of the container is a quadrilateral and the attachment comprises a total of four arms.

26. (canceled)

27. An ISO modal container according to claim 1, wherein two attachments are provided for the pressure vessel, one for supporting each end cap of the pressure vessel.

28. (canceled)

29. (canceled)

30. (canceled)

31. (canceled)

32. A ship carrying a plurality of ISO modal containers as defined in claim 1.
